(19) United States
(12) Patent Application Publication
(10) Pub. No.: US 2022/0247038 A1
(43) Pub. Date: Aug. 4, 2022

(54) SECONDARY BATTERIES

(71) Applicant: SOLVAY SPECIALTY POLYMERS ITALY S.P.A., Bollate (IT)

(72) Inventors: Julio A. ABUSLEME, Saronno (IT); Andrea Vittorio ORIANI, Milano (IT); Ségolène BRUSSEAU, Tavaux (FR)

(21) Appl. No.: 17/619,423

(22) PCT Filed: Jul. 16, 2020
(86) PCT No.: PCT/EP2020/070127

§ 371 Date: Dec. 15, 2021

(30) Foreign Application Priority Data
Jul. 29, 2019 (EP) 19315080.2

(51) Int. Cl. H01M 50/449; H01M 50/426; H01M 50/42; H01M 50/403; H01M 10/0525; H01M 4/62

(52) U.S. Cl. CPC H01M 50/449; H01M 50/426; H01M 4/623; H01M 50/403; H01M 10/0525; H01M 50/42

(57) ABSTRACT

The present invention pertains to separators for electrochemical devices comprising vinylidene fluoride copolymers having improved thermal stability, to a process for their manufacture, and to electrochemical devices comprising the same.

### CROSS-REFERENCE TO RELATED APPLICATIONS

This application claims priority to European application No. 19315080.2 filed on Jul. 29, 2019, the whole content of this application being incorporated herein by reference for all purposes.

### TECHNICAL FIELD

The present invention pertains to separators for electrochemical devices comprising vinylidene fluoride copolymers having improved thermal stability, to a process for their manufacture, and to electrochemical devices comprising the same.

### BACKGROUND ART

Lithium-ion batteries have become essential in our daily life. In the context of sustainable development, they are expected to play a more important role because they have attracted increasing attention for uses in electric vehicles and renewable energy storage.

Separator layers are important components of batteries. These layers serve to prevent contact of the anode and cathode of the battery while permitting electrolyte to pass there through.

The performance of a separator in a lithium ion battery is determined by some requirements such as porosity, chemical stability, electrical insulator, wettability, dimensional stability, and resistance to degradation by chemical reagents and electrolytes. Additionally, the separator should have good thermal stability in order to stand long service and resistance to temperature peaks when the battery in use.

Vinylidene fluoride (VDF) polymers are known in the art to be suitable as the manufacture of composite separators, and as coatings of porous separators for use in non-aqueous-type electrochemical devices such as batteries, preferably secondary batteries.

Known for example from Lee et al., J. Polym. Sci. Part B Polym. Phys. 2013, 51, 349-357, is the coating of polypropylene microporous separators with electrospun nanoparticles of poly vinylidene fluoride-co-chlorotrifluoroethylene (PVDF-co-CTFE). However, PVDF-co-CTFE copolymers are characterized by unsatisfactory thermal stability, lower than that of PVDF homopolymers.

VDF polymers are also known for the preparation of binders for electrodes. WO 2008/129041 (SOLVAY SPECIALTY POLYMERS ITALY S.P.A.) discloses VDF copolymers comprising recurring units derived from at least one (meth)acrylic comonomer and at least another fluorinated comonomer, being different from VDF, as binders for electrodes which impart a very good adhesion of the electrodes to the current collector.

The adhesion between separator and electrode is another important feature in battery cell assembly, which could improve the battery performance characteristics and the ease of handling during manufacturing.

EP2631974 (SAMSUNG SDI) proposes improving the adhesion strength between the negative electrode and the separator in a lithium battery wherein the negative electrode binder includes a VDF-based copolymer by coating at least one surface of a separator with a PVDF homopolymer layer.

In the technical field of batteries, notably of lithium batteries, the problem of providing a coated separator capable of providing good outstanding adhesion to the separator substrate material and which at the same time improves the adhesion of the separator to electrodes and has good lamination strength, conductivity and a similar or better thermal stability than the electrodes polymer binder is felt.

### SUMMARY OF INVENTION

Accordingly, the Applicant faced the problem of providing a polymer suitable for coating the substrate material of a separator for an electrochemical cell, said polymer being such to provide at the same time outstanding adhesion to the separator base material and improved adhesion of the coated separator to electrodes, thus improving the long term performances of the battery.

Surprisingly, the Applicant found that when a separator for an electrochemical cell is at least partially coated with a vinylidene fluoride-chlorotrifluoroethylene copolymer comprising recurring units derived from hydrophilic (meth)acrylic monomers randomly distributed throughout the whole vinylidene fluoride-chlorotrifluoroethylene copolymer backbone, said problem can be solved.

Thus, in a first aspect, the present invention relates to a coated separator for electrochemical devices comprising a substrate layer (P) at least partially coated with a vinylidene fluoride copolymer (polymer (F)) obtained by copolymerizing vinylidene fluoride (VDF), chlorotrifluoroethylene (CTFE) and at least one hydrophilic (meth)acrylic monomer (MA) being continuously fed to the reactor during copolymerization.

Surprisingly, the presence of recurring units derived from hydrophilic (meth)acrylic monomers randomly distributed throughout the whole vinylidene fluoride-chlorotrifluoroethylene copolymer backbone improves the thermal stability of the vinylidene fluoride-chlorotrifluoroethylene copolymer itself.

In a second aspect, the invention pertains to a process for the preparation of a coated separator for electrochemical devices as defined above, said process comprising the steps of:
i) providing a non-coated substrate layer (P);
ii) providing a coating composition (composition (C)) comprising a vinylidene fluoride copolymer (polymer (F)) obtained by copolymerizing vinylidene fluoride (VDF), chlorotrifluoroethylene (CTFE) and at least one hydrophilic (meth)acrylic monomer (MA), the monomer (MA) being continuously fed to the reactor during copolymerization;
iii) applying the coating composition (C) of step ii) at least partially on at least one portion of the substrate layer (P); and
iv) drying the at least partially coated substrate layer (P) of step iii).

In a further aspect, the present invention pertains to an electrochemical device comprising the coated separator as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content (TSC) of a liquid composition, weight percent (wt %) indicates the ratio between the weight of all non-volatile ingredients in the liquid.

By the term “separator”, it is hereby intended to denote a porous monolayer or multilayer polymeric material, which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

In the context of the invention, the term “substrate layer” is hereby intended to denote either a monolayer substrate consisting of a single layer or a multilayer substrate comprising at least two layers adjacent to each other.

The substrate layer (P) can be made by any porous substrate or fabric commonly used for a separator in electrochemical device, comprising at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene and polypropylene, or a mixture thereof. Preferably, the substrate layer (P) is polyethylene or polypropylene.

The term “(meth)acrylic monomer” as employed herein includes acrylic and/or methacrylic acid, esters of acrylic or methacrylic acid and derivatives and mixtures thereof.

The term “at least one hydrophilic (meth)acrylic monomer (MA)” is understood to mean that the polymer (A) may comprise recurring units derived from one or more than one hydrophilic (meth)acrylic monomer (MA) as above described. In the rest of the text, the expressions “hydrophilic (meth)acrylic monomer (MA)” and “monomer (MA)” are understood, for the purposes of the present invention, both in the plural and the singular, that is to say that they denote both one or more than one hydrophilic (meth)acrylic monomer (MA).

The hydrophilic (meth)acrylic monomer (MA) preferably complies formula (I):

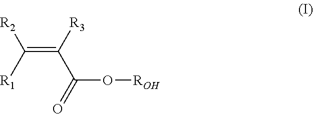

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group and/or at least a carboxylic group.

More preferably, the hydrophilic (meth)acrylic monomer (MA) preferably complies formula (II):

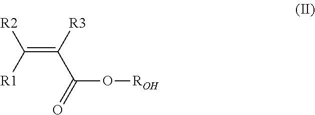

wherein each of R1, R2, R_{OH} have the meanings as above defined, and R3 is hydrogen; more preferably, each of R1, R2, R3 are hydrogen, while R_{OH} has the same meaning as above detailed.

Non limitative examples of hydrophilic (meth)acrylic monomers (MA) are notably acrylic acid, methacrylic acid, hydroxyethyl (meth)acrylate, hydroxypropyl(meth)acrylate; hydroxyethylhexyl(meth)acrylates.

The monomer (MA) is more preferably selected among:
hydroxyethylacrylate (HEA) of formula:

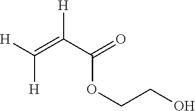

2-hydroxypropyl acrylate (HPA) of either of formulae:

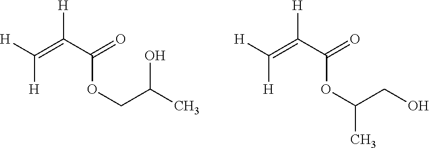

acrylic acid (AA) of formula:

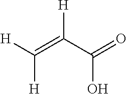

and mixtures thereof.

Most preferably, the monomer (MA) is AA and/or HEA.

Polymer (F) may still comprise other moieties such as defects, end-groups and the like, which do not affect nor impair its physico-chemical properties.

Polymer (F) is semi-crystalline. The term semi-crystalline is intended to denote a polymer (F) which possesses a detectable melting point. It is generally understood that a semi-crystalline polymer (F) possesses a heat of fusion determined according to ASTM D 3418 of advantageously at least 0.4 J/g, preferably of at least 0.5 J/g, more preferably of at least 1 J/g.

Polymer (F) is a linear copolymer, that is to say, it is composed of macromolecules made of substantially linear sequences of recurring units from VDF monomer, from CTFE monomer and (MA) monomer; polymer (F) is thus distinguishable from grafted and/or comb-like polymers.

Polymer (F) comprises preferably at least 0.05% by moles, more preferably at least 0.1% by moles, even more preferably at least 0.5% by moles of recurring units derived from CTFE.

Polymer (F) comprises preferably at most 10% by moles, more preferably at most 7% by moles, even more preferably at most 5% by moles of recurring units derived from CTFE.

Polymer (F) comprises preferably at least 0.05% by moles, more preferably at least 0.1% by moles, even more preferably at least 0.2% by moles of recurring units derived from said hydrophilic (meth)acrylic monomer (MA).

Polymer (F) comprises preferably at most 2% by moles, more preferably at most 1.8% by moles, even more preferably at most 1.5% by moles of recurring units derived from said hydrophilic (meth)acrylic monomer (MA).

In a more preferred embodiment, polymer (F) comprises recurring units derived from CTFE in an amount ranging from 0.5 to 10% by moles and recurring units derived from said hydrophilic (meth)acrylic monomer (MA) in an amount ranging from 0.2 to 1.5% by moles.

In a preferred embodiment of the invention, in polymer (F) the recurring units derived from hydrophilic (meth)acrylic monomer (MA) of formula (I) are comprised in an amount of from 0.2 to 1% by moles with respect to the total moles of recurring units of polymer (F), and the recurring units derived from CTFE are comprised in an amount of from 0.5 to 4% by moles with respect to the total moles of recurring units of polymer (F).

More preferably, the hydrophilic (meth)acrylic monomer (MA) is a hydrophilic (meth)acrylic monomer of formula (II), still more preferably it is acrylic acid (AA), and polymer (F) is a VDF-AA-CTFE terpolymer.

The polymer (F) has advantageously an intrinsic viscosity, measured in dimethylformamide at 25° C., of above 0.15 l/g and at most 0.60 l/g, preferably in the range of 0.20-0.50 l/g, more preferably comprised in the range of 0.25-0.40 l/g.

The preparation of the polymer (F) is a production method for a vinylidene fluoride copolymer comprising copolymerizing vinylidene fluoride (VDF), chlorotrifluoroethylene (CTFE) and at least one hydrophilic (meth)acrylic monomer (MA), the compound of formula (I) being added to the VDF and CTFE continuously during copolymerization.

The expressions “continuous feeding”, “adding continuously” or “continuously feeding” means that slow, small, incremental additions the aqueous solution of hydrophilic (meth)acrylic monomer (MA) take place until polymerization has concluded.

The polymer (F) thus obtained has a high uniformity of monomer (MA) distribution in the polymer backbone, which advantageously maximizes the effects of the modifying monomer (MA) on both adhesiveness and/or hydrophilic behaviour of the resulting copolymer.

In addition, the Applicant has surprisingly found that the presence of the monomer (MA) uniformly distributed in the polymer (F) has the effect of improving the thermal stability of VDF-CTFE copolymers, which otherwise is unsatisfactorily low, in particular lower than that of VDF homopolymers.

The polymer (F) is typically obtainable by emulsion polymerization or suspension polymerization of at least one VDF monomer, at least one hydrogenated (meth)acrylic monomer (MA) and CTFE, according to the procedures described, for example, in WO 2008/129041.

In a second aspect, the invention pertains to a process for the preparation of a coated separator for electrochemical devices as defined above.

In step ii) of the process, a composition (C) comprising polymer (F) as above defined is provided.

Composition (C) preferably comprises a polymer (F) as above defined and a solvent (S).

The choice of the solvent (S) is not particularly limited, provided that it is suitable for solubilising the polymer (F).

The solvent (S) is typically selected from the group consisting of:
alcohols such as methyl alcohol, ethyl alcohol and diacetone alcohol,
ketones such as acetone, methylethylketone, methylisobutyl ketone, diisobutylketone, cyclohexanone and isophorone,
linear or cyclic esters such as isopropyl acetate, n-butyl acetate, methyl acetoacetate, dimethyl phthalate and γ-butyrolactone,
linear or cyclic amides such as N,N-diethylacetamide, N,N-dimethylacetamide, dimethylformamide and N-methyl-2-pyrrolidone, and
dimethyl sulfoxide.

Composition (C) may further comprise at least one wetting agent and/or at least one surfactant and one or more than one additional additives.

Composition (C) may further comprise at least one non-electroactive inorganic filler material.

By the term “non-electroactive inorganic filler material”, it is hereby intended to denote an electrically non-conducting inorganic filler material, which is suitable for the manufacture of an electrically insulating separator for electrochemical cells.

The non-electroactive inorganic filler material in the separator according to the invention typically has an electrical resistivity (p) of at least 0.1×1010 ohm cm, preferably of at least 0.1×1012 ohm cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

Composition (C) can be prepared by any known method in the art, such as by a method comprising mixing polymer (F) with the solvent (S).

In step iii) of the process of the present invention, composition (C) obtained in step ii) is at least partially applied onto at least one portion of said substrate layer (P) by a technique selected from casting, spray coating, rotating spray coating, roll coating, doctor blading, slot die coating, gravure coating, ink jet printing, spin coating and screen printing, brush, squeegee, foam applicator, curtain coating, vacuum coating.

The present invention also relates to an electrochemical device comprising the coated separator as defined above, a positive electrode and a negative electrode.

Preferably, the electrochemical device is a secondary battery, preferably a lithium secondary battery.

In a preferred embodiment of the present invention, the lithium secondary battery comprises:
a coated separator as defined above,
a positive electrode, and
a negative electrode,
wherein at least one of the positive and the negative electrode is an electrode comprising an electrode active material and a binder, wherein said binder includes a vinylidene fluoride (VDF) copolymer [polymer (A)] comprising:
   recurring units derived from vinylidene fluoride (VDF),
   recurring units derived from acrylic acid in an amount of from 0.05 to 10% by moles, and,
optionally, recurring units derived from at least one perhalogenated monomer (FM) in an amount of from 0.5% to 5.0% by moles, preferably from 1.5 to 4.5% by moles, more preferably from 1.5% to 3.0% by moles, even more preferably from 2.0 to 3.0% by moles with respect to the total amount of moles of recurring units in said polymer (A).

In a more preferred embodiment of the present invention, the lithium secondary battery comprises:
a coated separator as defined above, wherein polymer (F) is a VDF-AA-CTFE terpolymer,
a positive electrode, and
a negative electrode,
wherein at least one of the positive and the negative electrode is an electrode comprising an electrode active material and a binder, wherein said binder includes a vinylidene fluoride (VDF) copolymer [polymer (A)] comprising:
   recurring units derived from vinylidene fluoride (VDF),
   recurring units derived from acrylic acid in an amount of from 0.05 to 10% by moles, and,
optionally, recurring units derived from at least one perhalogenated monomer (FM) in an amount of from 0.5% to 5.0% by moles, preferably from 1.5 to 4.5% by moles, more preferably from 1.5% to 3.0% by moles, even more preferably from 2.0 to 3.0% by moles with respect to the total amount of moles of recurring units in said polymer (A).

Polymer (A) is semi-crystalline. The term semi-crystalline is intended to denote a polymer (A) which possesses a detectable melting point. It is generally understood that a semi-crystalline polymer (A) possesses a heat of fusion determined according to ASTM D 3418 of advantageously at least 0.4 J/g, preferably of at least 0.5 J/g, more preferably of at least 1 J/g.

Polymer (A) is composed of macromolecules made of substantially linear sequences of recurring units from VDF monomer, from acrylic acid and, optionally, from monomer (FM); polymer (A) is thus distinguishable from grafted and/or comb-like polymers.

Polymer (A) comprises preferably at least 0.05% by moles, more preferably at least 0.1% by moles, even more preferably at least 0.5% by moles of recurring units derived from monomer (FM).

Polymer (A) comprises preferably at most 10% by moles, more preferably at most 7% by moles, even more preferably at most 5% by moles of recurring units derived from monomer (FM).

Non-limiting examples of suitable monomers (FM) include, notably, the followings:
C₂-C₈ perfluoroolefins such as tetrafluoroethylene and hexafluoropropylene (HFP);
C₂-C₈ hydrogenated fluoroolefins such as vinyl fluoride, 1,2-difluoroethylene and trifluoroethylene;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins such as chlorotrifluoroethylene (CTFE);
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles, preferably perfluorodioxoles.

The fluorinated monomer (FM) is preferably chlorotrifluoroethylene (CTFE) or hexafluoropropylene (HFP).

Polymer (A) may still comprise other moieties such as defects, end-groups and the like, which do not affect nor impair its physico-chemical properties.

Suitable polymers (A) are typically prepared as described in the art (see e.g. WO 2008/129041 and WO 2019/101806).

In a preferred embodiment of the present invention, the polymer (A) is a VDF-AA copolymer.

In another preferred embodiment of the present invention, polymer (A) is a VDF-AA-CTFE terpolymer.

In a preferred embodiment of the present invention, the lithium secondary battery comprises:
a coated separator comprising a substrate layer (P) at least partially coated with a polymer (F) that is a VDF-AA-CTFE wherein the recurring units deriving from AA are comprised in an amount of from 0.2 to 1% by moles with respect to the total moles of recurring units of polymer (F), and the recurring units derived from CTFE are comprised in an amount of from 0.5 to 4% by moles with respect to the total moles of recurring units of polymer (F);
a positive electrode, and
a negative electrode,
wherein at least one of the positive and the negative electrode is an electrode comprising an electrode active material and a binder, wherein said binder includes a VDF-AA copolymer.

In a still more preferred embodiment of the present invention, the lithium secondary battery comprises:
a coated separator comprising a substrate layer (P) at least partially coated with a polymer (F) that is a VDF-AA-CTFE wherein the recurring units deriving from AA are comprised in an amount of from 0.2 to 1% by moles with respect to the total moles of recurring units of polymer (F), and the recurring units derived from CTFE are comprised in an amount of from 0.5 to 4% by moles with respect to the total moles of recurring units of polymer (F);
   a positive electrode, and
a negative electrode,
wherein at least one of the positive and the negative electrode is an electrode comprising an electrode active material and a binder, wherein said binder includes a vinylidene fluoride (VDF) copolymer [polymer (A)] that is a VDF-AA-CTFE terpolymer.

The Applicant has surprisingly found that when the binder of at least one of the positive and the negative electrode comprises a polymer (A) the adhesion of the at least partially coated separator of the present invention with said at least one electrode is greatly enhanced.

Without wishing to be bound to by any theory, the inventors believe that the presence in both the coating of the separator and in the binder of the electrode(s) of a polymer including an acrylic monomer structure, namely the hydrophilic (meth)acrylic monomer (MA) and the acrylic acid monomer, respectively, is responsible for the improvement in compatibility between separator and electrode(s), thus resulting in the greatly enhanced adhesion of the at least partially coated separator of the present invention with the electrode(s).

The positive and the negative electrode prepared by using a binder including the polymer (A) as above defined, can be prepared according to any procedure known to the skilled person.

When using the polymer (A) as a binder for an electrode, a binder solution of polymer (A) is generally prepared.

The organic solvent used for dissolving the polymer (A) to provide the binder solution according to the present invention may preferably be a polar one, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. As the vinylidene fluoride polymer used in the present invention has a much larger polymerization degree than a conventional one, it is further preferred to use a nitrogen-containing organic solvent having a larger dissolving power, such as N-methyl-2-pyrrolidone, N,N-dimethylformamide or N,N-dimethylacetamide among the above-mentioned organic solvents. These organic solvents may be used singly or in mixture of two or more species.

For obtaining the binder solution of polymer (A) as above detailed, it is preferred to dissolve 0.1-10 wt parts, particularly 1-5 wt parts, of the copolymer (A) in 100 wt parts of such an organic solvent. Below 0.1 wt part, the polymer occupies too small a proportion in the solution, thus being liable to fail in exhibiting its performance of binding the powdery electrode material. Above 10 wt parts, an abnormally high viscosity of the solution is obtained, so that not only the preparation of the electrode-forming composition becomes difficult but also avoiding gelling phenomena can be an issue.

In order to prepare the polymer (A) binder solution, it is preferred to dissolve the copolymer (A) in an organic solvent at an elevated temperature of 30-200° C., more preferably 40-160° C., further preferably 50-150° C. Below 30° C., the dissolution requires a long time and a uniform dissolution becomes difficult.

An electrode-forming composition may be obtained by adding and dispersing a powdery electrode material (an active substance for a battery or an electric double layer capacitor), and optional additives, such as an electroconductivity-imparting additive and/or a viscosity modifying agent, into the thus-obtained polymer (A) binder solution.

In the case of forming a positive electrode for a lithium ion battery, the active substance may comprise a composite metal chalcogenide represented by a general formula of LiMY₂, wherein M denotes at least one species of transition metals such as Co, Ni, Fe, Mn, Cr and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCo₁₋ₓO₂ (0<x<1), and spinel-structured LiMn₂O₄.

As an alternative, still in the case of forming a positive electrode for a lithium ion battery, the active substance may comprise a lithiated or partially lithiated transition metal oxyanion-based electrode materials of the nominal formula AB(XO₄)_{f}E_{1-f}, in which A is lithium, which may be partially substituted by another alkali metal representing less that 20% of the A metals, B is a main redox transition metal at the oxidation level of +2 chosen among Fe, Mn, Ni or mixtures thereof, which may be partially substituted by one or more additional metal at oxidation levels between +1 and +5 and representing less than 35% of the main +2 redox metals, including 0, XO₄ is any oxyanion in which X is either P, S, V, Si, Nb, Mo or a combination thereof, E is a fluoride, hydroxide or chloride anion, f is the molar fraction of XO₄ oxyanion, generally comprised between 0.75 and 1 (extremes included).

The above AB(XO₄)_{f}E_{1-f} active substances are preferably phosphate-based and may have an ordered or modified olivine structure.

More preferably, the active substance as above described complies with formula Li₃₋ₓM′_{y}M″_{2-y}(XO₄)₃ in which: 0≤x≤3, 0≤y≤2; M′ and M″ are the same or different metals, at least one of which being a redox transition metal; XO₄ is mainly PO₄ which may be partially substituted with another oxyanion, in which X is either P, S, V, Si, Nb, Mo or a combination thereof. Still more preferably, the active material is a phosphate-based electrode material having the nominal formula Li(FeₓMn₁₋ₓ)PO₄ in which 0≤x≤1, wherein x is preferably 1 (that is to say, Lithium Iron Phosphate of formula: LiFePO₄).

In the case of forming a negative electrode for a lithium battery, the active substance may preferably comprise a carbon-based material and/or a silicon-based material.

In some embodiments, the carbon-based material may be, for example, graphite, such as natural or artificial graphite, graphene, or carbon black.

These materials may be used alone or as a mixture of two or more thereof.

The carbon-based material is preferably graphite.

The carbonaceous material may preferably be used in the form of particles having an average diameter of ca. 0.5-100 μm.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present, the at least one silicon-based compound is comprised in the active substance in an amount ranging from 1 to 30% by weight, preferably from 5 to 10% by weight with respect to the total weight of the active substance.

An electroconductivity-imparting additive may be added in order to improve the conductivity of a resultant composite electrode layer formed by applying and drying of the electrode-forming composition of the present invention, particularly in case of using an active substance, such as LiCoO₂ or LiFePO₄, showing a limited electron-conductivity. Examples thereof may include: carbonaceous materials, such as carbon black, graphite fine powder and fiber, and fine powder and fiber of metals, such as nickel and aluminum.

The active substance for an electric double layer capacitor may preferably comprise fine particles or fiber, such as activated carbon, activated carbon fiber, silica or alumina particles, having an average particle (or fiber) diameter of 0.05-100 μm and a specific surface area of 100-3000 m²/g, i.e., having a relatively small particle (or fiber) diameter and a relatively large specific surface area compared with those of active substances for batteries.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

### Examples

Raw Materials

Polymer A-1: VDF-AA (0.9% by moles) polymer having an intrinsic viscosity of 0.30 l/g in DMF at 25° C. and a T_{2f} of 162° C., obtained as described in WO 2008/129041.

Polymer A-2: VDF-AA (0.2% by moles) polymer having an intrinsic viscosity of 0.35 l/g in DMF at 25° C. and a T_{2f} of 167° C., obtained as described in WO 2008/129041.

Polymer (F-1): VDF-AA (0.9% by moles)-CTFE (0.56% by mole) polymer having an intrinsic viscosity of 0.35 l/g in DMF at 25° C. and a T_{2f} of 161.6° C.

Polymer (F-2): VDF-AA (0.2% by moles)-CTFE (3.7% by moles) polymer having an intrinsic viscosity of 0.352 l/g in DMF at 25° C. and a T_{2f} of 161.3° C.

Initiator agent (TAPPI): t-amyl-perpivalate in isododecane (a 75% by weight solution of t-amyl perpivalate in isododecane), commercially available from Arkema.

Suspending agent B1: Alcotex AQ38, a 38 g/l solution of Alcotex 80 in water: 80% hydrolyzed high molecular weight polyvinyl alcohol, commercially available from SYNTHOMER.

Suspending agent B2: Bermocoll® E230FQ from AkzoNobel.

Active material NMC: LiNi_{0.6}Co_{0.2}Mn_{0.2}O₂, commercially available from Umicore SA.

Electroconductivity-imparting additive: C-NERGY™ SUPER C65 (SC-65), commercially available from Imerys Graphite & Carbon.

Determination of Intrinsic Viscosity of Polymer

Intrinsic viscosity (η) [dl/g] was measured using the following equation on the basis of dropping time, at 25° C., of a solution obtained by dissolving the polymer (A) in N,N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and Γ is an experimental factor, which for polymer (A) corresponds to 3.

DSC Analysis

DSC analyses were carried out according to ASTM D 3418 standard; the melting point (Tf₂) was determined at a heating rate of 10° C./min.

Preparation of Polymer F-1

In a 4 liters reactor equipped with an impeller running at a speed of 650 rpm were introduced in sequence 1913 g of demineralised water and 1.6 g/kg Mni (initial of monomers added in reactor before the set point temperature) of suspending agent B1. The reactor was purged with sequence of vacuum (30 mmHg) and purged of nitrogen at 20° C. Then 4.57 g of TAPPI was introduced. At a speed of 880 rpm, 0.44 g of acrylic acid (AA), 14 g of chlorotrifluoroethylene (CTFE), and 1348 g of vinylidene fluoride (VDF) were introduced. The reactor was gradually heated until a set-point temperature at 55° C. and the pressure was fixed at 120 bar. The pressure was kept constantly equal to 120 bar by feeding during the polymerization 1041 g of acrylic acid water solution at a concentration of acrylic acid fixed at 10.12 g/kg of water. After this feeding, no more water was introduced and the pressure started to decrease and the polymerization was stopped by degassing the reactor until reaching atmospheric pressure. A conversion of all the monomers at 86% was reached. The polymer so obtained was then recovered, washed with demineralized water and dried at 65° C. during all the night.

Preparation of Polymer F-2

In a 80 litres reactor equipped with an impeller running at a speed of 250 rpm were introduced in sequence 44.8 kg of demineralised water and 1.6 g/kg Mni ((initial of monomers added in reactor before the set point temperature) of suspending agent B2. The reactor was purged with sequence of vacuum (30 mmHg) and purged of nitrogen at 20° C. Then 37.47 g of TAPPI and 102.6 g of diethyl carbonate (DCE) were added. The speed of the stirring was increased at 300 rpm. Finally, 2.81 g of acrylic acid (AA), 1.4 kg of chlorotrifluoroethylene (CTFE) and 26.6 kg of vinylidene fluoride (VDF) were introduced in the reactor. The reactor was gradually heated until a set-point temperature at 55° C. and the pressure was fixed at 120 bar. The pressure was kept constantly equal to 120 bar by feeding 20.6 kg g of a water solution of acrylic acid with a concentration of AA at 3.27 g/kg of water. After this feeding, no more aqueous solution was introduced and the pressure started to decrease. Then, the polymerization was stopped by degassing the reactor until reaching atmospheric pressure. A conversion of 87% of comonomers was obtained. The polymer so obtained was then recovered, washed with demineralised water and dried at 65° C.

Preparation of Comparative Polymer 1:

The polymerization conditions and ingredients are those described in preparation of polymer F-2 except that the acrylic acid was fed all at the beginning of the polymerization. The pressure was kept constantly equal to 120 bar by feeding during the polymerization demineralized water (instead of the acrylic acid solution). After this feeding, no more water was introduced and the pressure started to decrease and the polymerization was stopped by degassing the reactor until reaching atmospheric pressure. 84% conversion of monomers was reached. The polymer so obtained was then recovered, washed with demineralized water and dried at 65° C. during all the night. From the T_{2f} we can also conclude that in comparison with F-2 the distribution is not random since the T_{2f} is higher than that of F-2. This is typical of heterogeneous distribution of comonomers units in the polymers.

Thermal Stability of PVDF Homopolymer and VDF-CTFE Copolymer

A TGA dynamic under nitrogen was carried out at a heating rate of 10° C./min on the following polymers:

Polymer a: PVDF homopolymer having intrinsic viscosity of about 0.1 l/g in DMF at 25° C.; and

Polymer b: VDF-CTFE (8.4% by mole) polymer having an intrinsic viscosity of about 0.10 l/g in DMF at 25° C.

The temperatures at which the two polymers a and b loss in weight of 1%, of 2% and of 10% have been recorded. The results are shown in Table 1.

TABLE 1

Polymer

| | b | a |
|---|---|---|
| T loss @ 1% | 415 | 450 |
| T loss@ 2% | 426 | 461 |
| T loss@ 10% | 447 | 478 |

The results show that a VDF-CTFE polymer, namely Polymer b, has a lower thermal stability in comparison with a PVDF homopolymer, namely Polymer a.

Thermal Stability

A TGA analysis under nitrogen at 200° C. at a heating rate of 10° C./min was carried on polymers F-1 and F-2 and on polymers A-1 and A-2.

The results are shown in Table 2.

TABLE 2

| | | % weight loss @ 200° C. |
|---|---|---|
| Polymer | % weight loss @ 200° C. | vs polymer A-1 |
| A-1 | 0.13 | 100% |
| F-1 | 0.05 | 36% |
| A-2 | 0.12 | 92% |
| F-2 | 0.08 | 63% |

The results shows that the polymers F-1 and F-2, for use in the separators of the invention, have better thermal stability than the polymers A-1 and A-2, used in the prior art as binders for electrodes.

Chemical Stability

The chemical resistance to basic substances of the polymer F-1 has been compared with that of polymer A-1. The test was carried out on a 5 wt % solution of polymer in NMP, to which DEA (diethyl-amine) was added in an amount to provide a concentration of 0.3 wt % in NMP. After 4 hours the polymer degradation (presence of conjugated double bonds) was observed by UV-vis detector.

The results show that the degradation of polymer F-1 was, in relative percentage terms, of 35% with respect to that of polymer A-1.

General Preparation of the Electrodes

In order to compare the adhesion behaviour of polymers F-1 and F-2, for use in the separators of the invention, with those commonly used in the art as electrode binders, namely polymers A-1 and A-2, compositions were prepared by pre-mixing for 10 minutes in a centrifugal mixer 14.9 g of a 8% by weight solution of a polymer (F-1, F-2, A-1 and A-2) in NMP, 115.4 g of NMC, 2.4 g of SC-65 and 37.7 g of NMP.

The mixtures were then mixed using a high speed disk impeller at 2000 rpm for 1 h. Positive electrodes were obtained by casting the so obtained compositions on 20 μm thick Al foil with a doctor blade and drying the coating layers so obtained in a vacuum oven at temperature of 90° C. for about 70 minutes. The thickness of the dried coating layers was about 110 μm.

The positive electrodes so obtained had the following composition: 97% by weight of NMC, 1% by weight of polymer, 2% by weight of conductive additive.

Adhesion Peeling Force Method

Peeling tests were performed on the electrodes prepared as above described, with the setup described in the standard ASTM D903 at a speed of 300 mm/min at 20° C. in order to evaluate the adhesion of the dried coating layer to the Al foil. The results are shown in Table 3.

TABLE 3

| | Adhesion | Normalized Adhesion |
|---|---|---|
| polymer | [N/m] | [%] |
| Comparative Polymer 1 | 4.31 | 37 |
| A-1 | 11.63 | 100 |
| A-2 | 22.39 | 193 |
| F-1 | 19.15 | 165 |
| F-2 | 14.05 | 121 |

In view of the above, it has been found that the electrodes prepared by using polymer F-1 as binder, wherein polymer F-1 has the recurring units deriving from monomer AA uniformly distributed in the polymer backbone, have a much higher adhesion to metal foil than that obtained by using Comparative Polymer 1, prepared by adding all the AA together at the beginning of the polymerization.

1-14. (canceled)

15. A coated separator for electrochemical devices comprising a substrate layer (P) at least partially coated with a vinylidene fluoride copolymer (polymer (F)) obtained by copolymerizing vinylidene fluoride chlorotrifluoroethylene and at least one hydrophilic (meth)acrylic monomer (MA), the at least one hydrophilic (meth)acrylic monomer (MA) being continuously fed to the reactor during copolymerization.

16. The coated separator according to claim 15 wherein the substrate layer (P) comprises at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene, polypropylene, and a mixture thereof.

17. The coated separator according to claim 15 wherein the hydrophilic (meth)acrylic monomer (MA) complies with formula (I): 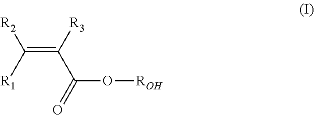
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group and/or at least a carboxylic group.

18. The coated separator according to claim 17 wherein the hydrophilic (meth)acrylic monomer (MA) complies with formula (II): 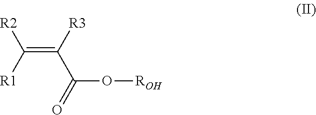
and/or at least a carboxylic group.

19. The coated separator according to claim 17, wherein the hydrophilic (meth)acrylic monomer (MA) is selected from the group consisting of:
hydroxyethylacrylate of formula: 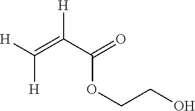
2-hydroxypropyl acrylate of either of formulae: 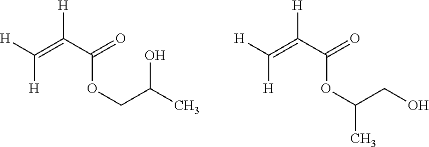
acrylic acid of formula: 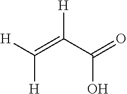
and mixtures thereof.

20. The coated separator according to claim 19, wherein the hydrophilic (meth)acrylic monomer (MA) is acrylic acid.

21. The coated separator according to claim 20 wherein polymer (F) comprises recurring units derived from chlorotrifluoroethylene in an amount ranging from 0.5 to 10% by moles and recurring units derived from acrylic acid in an amount ranging from 0.2 to 1.5% by moles.

22. A process for the preparation of the coated separator of claim 15, said process comprising the steps of:
i) providing a non-coated substrate layer (P);
ii) providing a coating composition (composition (C)) comprising a vinylidene fluoride (polymer (F)) obtained by copolymerizing vinylidene fluoride, chlorotrifluoroethylene and at least one hydrophilic (meth)acrylic monomer (MA), the at least one hydrophilic (meth)acrylic monomer (MA) being continuously fed to the reactor during copolymerization;
iii) applying the coating composition (C) of step ii) at least partially on at least one portion of the substrate layer (P); and
iv) drying the at least partially coated substrate layer (P) of step iii).

23. The process according to claim 22, wherein composition (C) further comprises a solvent (S).

24. The process according to claim 22, wherein composition (C) further comprises at least one wetting agent and/or at least one surfactant.

25. The process according to claim 22, wherein composition (C) further comprises at least one non-electroactive inorganic filler material.

26. An electrochemical device comprising:
a coated separator according to claim 15;
a positive electrode; and
a negative electrode;
wherein at least one of the positive and the negative electrode is an electrode comprising an electrode active material and a binder, wherein said binder includes a vinylidene fluoride copolymer [polymer (A)] comprising:
recurring units derived from vinylidene fluoride,
recurring units derived from acrylic acid in an amount of from 0.05 to 10% by moles, and,
optionally, recurring units derived from at least one perhalogenated monomer (FM) in an amount of from 0.5% to 5.0% by moles with respect to the total amount of moles of recurring units in said polymer (A).

27. The electrochemical device according to claim 26 wherein the coated separator comprises a substrate layer (P) at least partially coated with a vinylidene fluoride copolymer (polymer (F)) obtained by copolymerizing vinylidene fluoride chlorotrifluoroethylene and at least one hydrophilic (meth)acrylic monomer (MA), the at least one hydrophilic (meth)acrylic monomer (MA) being continuously fed to the reactor during copolymerization, wherein monomer (MA) is acrylic acid.

28. The electrochemical device according to claim 26 wherein monomer (FM) in polymer (A) is selected from chlorotrifluoroethylene and hexafluoropropylene.
